(19) United States
(12) Patent Application Publication
(10) Pub. No.: US 2017/0262148 A1
(43) Pub. Date: Sep. 14, 2017

(54) PAGE INFORMATION OPERATING METHOD AND APPARATUS, AND ELECTRONIC DEVICE

(71) Applicant: Alibaba Group Holding Limited, Grand Cayman (KY)

(72) Inventor: Yue Zhang, Zhejiang (CN)

(21) Appl. No.: 15/605,395

(22) Filed: May 25, 2017

Related U.S. Application Data
(63) Continuation of application No. PCT/CN2015/094795, filed on Nov. 17, 2015.

(30) Foreign Application Priority Data
Nov. 27, 2014 (CN) 201410705589.5

(51) Int. Cl. G06F 3/0485; G06F 3/0483

(52) U.S. Cl. CPC G06F 3/0485; G06F 3/0483

(57) ABSTRACT

The present disclosure discloses a page information operating method. The method may include, for example, adding a display label to a display area of a scrolling page; and moving the scrolling page correspondingly as the display label is moved by a user, and displaying designated information that enters the display area of the scrolling page onto the display label. As a user can quickly find content that the user desires to view conveniently by directly moving a display label, the user does not need to spend lots of time in frequently scrolling the scrolling page, thus avoiding a great number of interactions between the user and a terminal, and saving the resources of the terminal. In addition, the present disclosure further discloses an apparatus and an electronic device for operating page information.

### CROSS REFERENCE TO RELATED PATENT APPLICATIONS

This application claims priority to and is a continuation of PCT Patent Application No. PCT/CN2015/094795, filed on 17 Nov. 2015, which is related to and claims priority to Chinese Patent Application No. 201410705589.5, filed on 27 Nov. 2014, entitled “Page Information Operating Method and Device, and Electronic Apparatus,” which is hereby incorporated by reference in its entirety.

### TECHNICAL FIELD

The present disclosure relates to the field of the Internet, and in particular, to page information operating methods, apparatuses and electronic devices.

### BACKGROUND

A scrolling page or a long scrolling page, which is also referred to as a page with a masonry layout or a dynamic grid layout, is a relatively popular type of website page, and is visually presented as an uneven multi-column layout having a relatively long page length, with content being entered into a display area as the page is scrolled.

As a scrolling page is relatively long in page length and content thereof is scrolled as the page is scrolled, the scrolling page is especially suitable for presenting a large amount of content. For example, after a user searches for products within a specific price range in Taobao™, a large amount of product information within that specific price range searched by the user can be presented by means of a scrolling page.

However, when a scrolling page includes a relatively large amount of content, a user needs to spend a large amount of time in continuously scrolling the scrolling page in order to find designated information in the scrolling page that is desired. This is especially true when the user browses commodities in certain websites using an electronic device that has a touch screen. Commodities with prices of interest may be missed due to inertial scrolling of the user's finger.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

In view of the above, the present disclosure provides a method and an apparatus of operating page information, so that a user can quickly operate a scrolling page to display designated information desired thereby.

In implementations, a page information operating method is provided. The method may include, for example, displaying a display label in a display area of a page, the display label having first designated information at a first position, the first designated information associated with first content displayed in the display area; and changing a display of the page as the display label is moved by a user from the first position to a second position, the display label having second designated information at the second position, and the second designated information associated with second content displayed in the display area.

In implementations, a page information operating apparatus is provided. The apparatus may include, for example, a display label adding unit to add a display label into a display area of a page, the display label having first designated information at a first position, the first designated information associated with first content displayed in the display area; and a display label operating unit to change a display of the page as the display label is moved by a user from the first position to a second position, the display label having second designated information at the second position, and the second designated information associated with second content displayed in the display area.

In implementations, an electronic device is provided. The electronic device may include, for example, memory, processor(s), a touch screen, and at least one communication bus. The memory is used for storing program instructions. The program instructions that, when executed by the processor(s), cause the processor(s) to perform a method, which includes displaying a display label in a display area of a page that includes commodities and prices corresponding thereto, determining whether the display label is moved by a user based on touch position(s) sensed by the touch screen, moving the page correspondingly as the display label is moved by the user if affirmative, and displaying a price of a commodity that enters a designated position in the display area of the page onto the display label. The processor(s) is/are used for executing the program instructions stored in the memory. The touch screen is used for displaying the display area of the page, and transmitting the sensed touch position(s) when the touch screen is touched by the user to the processor(s). The communication bus is used for implementing connections and communications among the memory, the processor(s), and the touch screen.

As can be seen, the present disclosure has the following beneficial effects.

First, a display label is displayed in a display area of a page, the page is moved correspondingly as the display label is moved by a user, and designated information that enters the display area of the page is displayed on the display label. Therefore, the user can quickly determine content that the user desires to view based on the designated information displayed on the display label, and quickly move the desired content in the page into the display area, thus achieving an objective of enabling the user to quickly operate the page to display the desired content. As the user can quickly find the content that the user desires to view in a convenient manner of directly moving a display label, the user does not need to spend lots of time in continuously scrolling the page, thus avoiding a great number of interactions between the user and a terminal, and saving resources of the terminal.

Second, the program instructions executed by the processor(s) of the electronic device disclosed in the embodiments of the present disclosure may display a display label in a display area of a page that includes commodities and prices corresponding thereto, determine whether a user moves the display label based on touch position(s) sensed by the touch screen, move the page correspondingly as the display label is moved by the user if affirmative, and display a price of a commodity that enters a designated position in the display area of the page onto the display label. Therefore, when a user browses commodities in certain websites using the electronic device disclosed in the embodiments of the present disclosure, the user may quickly find commodities at prices of interest by directly moving a display label, and does not need to spend a large amount of time in continuously scrolling the page, thus avoiding a great number of interactions between the user and a terminal, and saving resources of the terminal.

### BRIEF DESCRIPTION OF THE DRAWINGS

In order to describe technical solutions in the embodiments of the present disclosure more clearly, the accompanying drawings are briefly described herein. Apparently, the accompanying drawings represent merely some embodiments of the present disclosure. Based on the accompanying drawings, one of ordinary skill in the art can also obtain other accompanying drawings without making any creative effort.

FIG. 1 is a flowchart of a page information operating method according to an embodiment of the present disclosure.

FIG. 2 is a schematic diagram of a scrolling page according to an embodiment of the present disclosure.

FIG. 3 is a schematic diagram of another scrolling page according to an embodiment of the present disclosure.

FIG. 4 is a structural diagram of a page information operating apparatus according to an embodiment of the present disclosure.

FIG. 5 is a structural diagram of another page information operating apparatus according to an embodiment of the present disclosure.

FIG. 6 is a structural diagram of an electronic device according to an embodiment of the present disclosure.

### DETAILED DESCRIPTION

In order to assist one skilled in the art to understand the technical solutions of the present disclosure in a better manner, the technical solutions in the embodiments of the present disclosure are clearly and comprehensively described hereinafter with reference to the accompanying drawings in the embodiments of the present disclosure. Apparently, the described embodiments represent only a part and not all of the embodiments of the present disclosure. Based on the embodiments of the present disclosure, all other embodiments, which are derived by one of ordinary skill in the art without making any creative effort, shall fall within the scope of protection of the present disclosure.

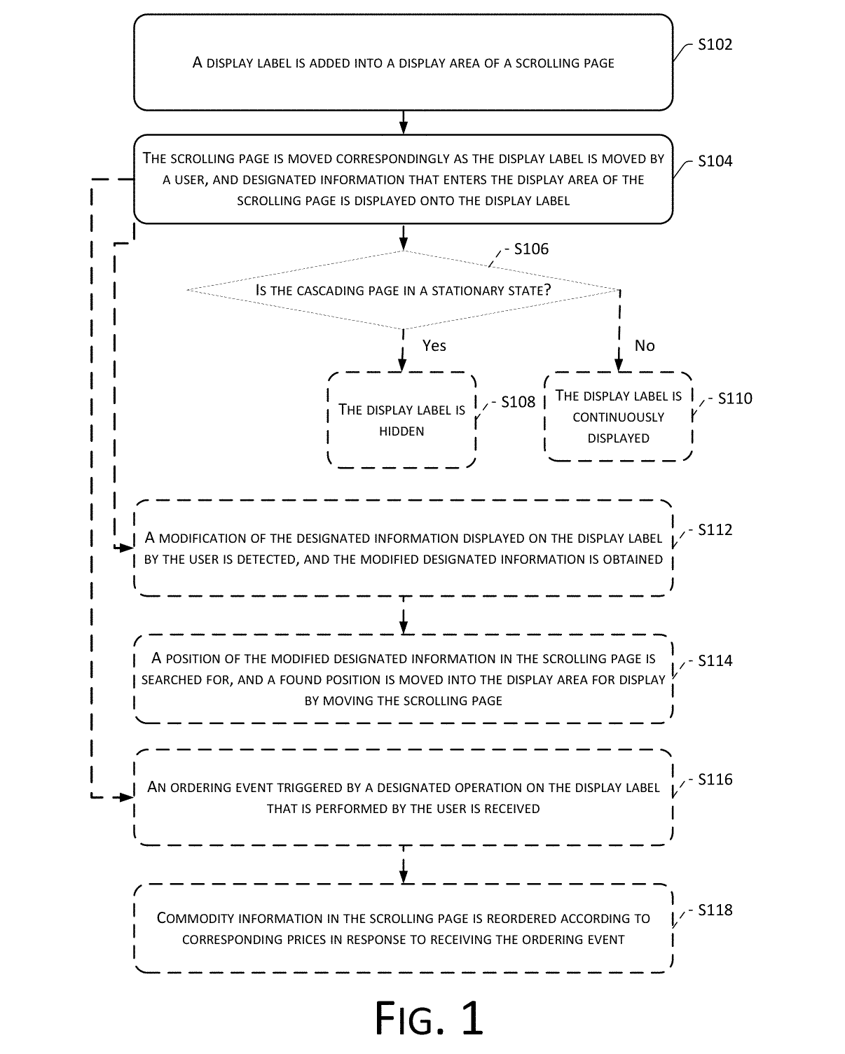

For example, FIG. 1 shows a flowchart of a page information operating method 100 according to an embodiment of the present disclosure. As shown in FIG. 1, the method 100 may include the following operations.

At S102, a display label is added into a display area of a scrolling page.

For example, the method may be applicable to a webpage browser. In implementation, adding a display label into a display area of a scrolling page may include adding an axis-shaped controller having the display label into a display window of a webpage browser in which the scrolling page is loaded. In implementations, the axis-shaped controller may further include a control axis, the control axis having a plurality of sections, and the plurality of sections individually corresponding to component ranges of respective sections of the total number of content elements in the scrolling page.

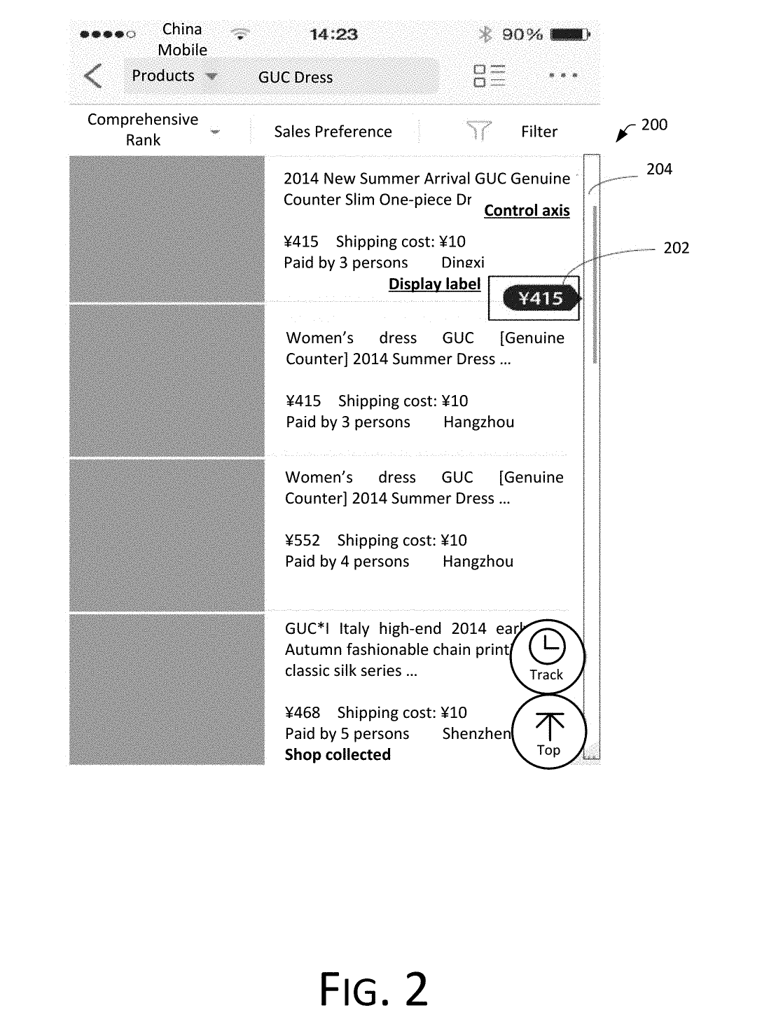

For example, the added axis-shaped controller may be an axis-shaped controller 200 as shown in FIG. 2. The axis-shaped controller 200 may include a display label 202 and a control axis 204.

The content elements of the scrolling page may all be obtained from a server at a time, or may be obtained from the server dynamically according to a scrolling state of the page. The webpage browser may request the total number of content elements in the scrolling page from the server. For example, when a user searches for a commodity in an e-commerce website using a webpage browser, a server may find all pieces of content that satisfies search criteria of the user according to search criteria, organize all the pieces of content as a scrolling page that is loadable to the webpage browser and calculate a total number of all content elements at the same time, and return the total number of all the content elements to the webpage browser.

In implementations, the total number of content elements may be the total number of pages of the scrolling page. The number of sections may be set according to the total number of pages, and a total length of the control axis may be equivalent to a total length of the scrolling page. In implementations, a color block that indicates a location of a page currently displayed by the webpage browser in the scrolling page may be added into the control axis, and the display label may be located at a designated position of the color block. For example, a gray block in a control axis as shown in FIG. 2 may correspond to the length of a sub-page, and a position of the gray block in a total control axis may indicate a position of the sub-page in the total length of the scrolling page. The display label may be in a left middle position of the gray block. For example, the sub-page currently displayed by the webpage browser is located at a position of ⅓ of the total page of the scrolling page from top to bottom, and the location of the gray block is then located at ⅓ of the control axis from top to bottom. It can be understood that setting a number of sections of a control axis according to a total number of pages of content elements with each section corresponding to a sub-page is merely an example implementation of the embodiments of the present disclosure. In reality, a number of sections of a control axis and a component range corresponding to each section may be set according to requirements of an implementation, which is not limited in the present disclosure.

At S104, the scrolling page is moved correspondingly as the display label is moved by a user, and designated information that enters the display area of the scrolling page is displayed onto the display label.

For example, with reference to the foregoing example of implementation applied to the webpage browser, the webpage browser may respond to moving of the display label by the user, determine a component range currently pointed by the display label according to a section on the control axis to which the display label is moved; and move, by moving the scrolling page, a content element which corresponds to the component range currently pointed by the display label in the scrolling page into the display window for display, and display designated information in the content element corresponding to the component range currently pointed onto the display label. For example, if a control axis is divided into ten sections according to ten sub-pages of a scrolling page with each section corresponding to a page, and a user moves a display label onto the fifth section of the control axis, a component range currently pointed by the display label is the fifth sub-page, content elements of the fifth sub-page of the scrolling page are moved into a display window of the webpage browser for display, and designated information on the fifth sub-page is displayed on the display label. For example, a price of a first product at top of the fifth sub-page may be displayed on the display label.

The designated information may be set according to actual requirements. For example, the designated information may be a brand of a first product displayed in a display area. For another example, the designated information may be a price of the first product displayed in the display area, etc.

In implementations, in order to prevent display content on the display label from being covered by a focal point of moving and becoming not viewable due to the user's moving of the display label, the designated information displayed on the display label is displayed in a visible area that is not covered by a focal point of moving during a process of moving the display label by the user. For example, in an implementation of which the embodiments of the present disclosure are applied to a touch screen based terminal, a determination may be made that a user begins to move a display label upon determining that the user touches the display label displayed by the touch screen, and content on the display label is displayed in an area at the top of the display label, which is not pressed by a finger.

In implementations, in order for the display label not to block the user from browsing page content, the method 100 may further include determining whether the scrolling page is in a stationary state or a moving state at S106; and hiding the display label in response to determining that the scrolling page is in a stationary state at S108, or (continuously) displaying the display label in response to determining that the scrolling page is in a moving state at 5110. For example, a scrolling page may be determined to be in a stationary state if the scrolling page is not scrolled for more than a preset time duration (e.g., two seconds), and the scrolling page is determined to be in a moving state if the scrolling page is scrolled.

In implementations, all the content elements in the scrolling page are ordered according to a designated ordering rule. The designated information may be a content element located at a designated ordering position from among all the content elements that enter the display area. For example, content included in the scrolling page is product information that satisfies a user search criterion, and the product information may be ordered in the scrolling page according to an ascending or descending order of product prices. The designated information may be a price of a product entering the display area in the scrolling page and is located at the first position.

In implementations, the method 100 may further include responding to a modification of the designated information displayed on the display label by the user, and obtaining the modified designated information at S112; and searching for a position of the modified designated information in the scrolling page, and moving a found position into the display area for display by moving the scrolling page at S114. In combination with the foregoing implementations applied to the webpage browser, the display label may be moved to a corresponding section of the control axis according to the position of the modified designated information in the scrolling page, and a color block for displaying a location of a current page in the scrolling page may be moved correspondingly. In implementations, as the user can search for content corresponding to the designated information that the user desire to view for display by modifying the designated information displayed on the display label directly, the user can input a search criterion without scrolling the scrolling page back to a page for an input filtering field, so that a corresponding position of the scrolling page enters the display area, thus achieving the objective of rapidly positioning target content of the scrolling page.

In implementations, the scrolling page may be a scrolling page including commodity information and prices corresponding thereto. The designated information is a price corresponding to a commodity entering a designated position of the display area in the scrolling page. In implementations, the method 100 may further include receiving an ordering event triggered by a designated operation on the display label that is performed by the user at S116; and reordering the commodity information in the scrolling page according to the corresponding prices in response to receiving the ordering event at S118. As the user is allowed to perform a designated operation on the display label to reorder commodities, the user does not need to return to the beginning of the scrolling page to click on an ordering button, thus avoiding additional interactions between the user and a terminal, and saving the resources of the terminal. For another example, in implementations, the commodities may be reordered after the user modifies the prices displayed on the display label and/or finds commodities corresponding to desired prices. Alternatively, commodities at prices of interest may be positioned by modifying the prices displayed on the display label after the commodities are reordered.

It should be noted that the embodiments of the present disclosure do not have any limitations on specific ways of implementations of a designated operation for a user to trigger an ordering event, which may be set according to requirements of a real application. In implementations, a control for triggering an ascending order and/or a control for triggering a descending order may be set up on the display label, for example. When a user clicks the control for triggering the ascending order (e.g., an ascend button displayed as an up arrow), commodity information in the scrolling page may be reordered in an ascending order according to corresponding prices. When the user clicks the control for triggering the descending order (e.g., a descend button displayed as a down arrow), commodity information in the scrolling page may be reorder in a descending order according to the corresponding prices.

As can be seen, by using the disclosed method, a user may quickly determine content that the user desires to view according to designated information displayed on a display label in a process of moving the display label in a display area, and thus the content of a scrolling page that the user desires to view is quickly moved into the display area, thereby achieving an objective of enabling the user to conveniently operate the scrolling page to display the content that the user desires to view. Significantly, as the user can quickly find the content that the user desires to view via a convenient manner of directly moving the display label, the user does not need to spend a large amount of time in frequently scrolling the scrolling page, thus avoiding a great number of interactions between the user and a terminal, and saving the resources of the terminal.

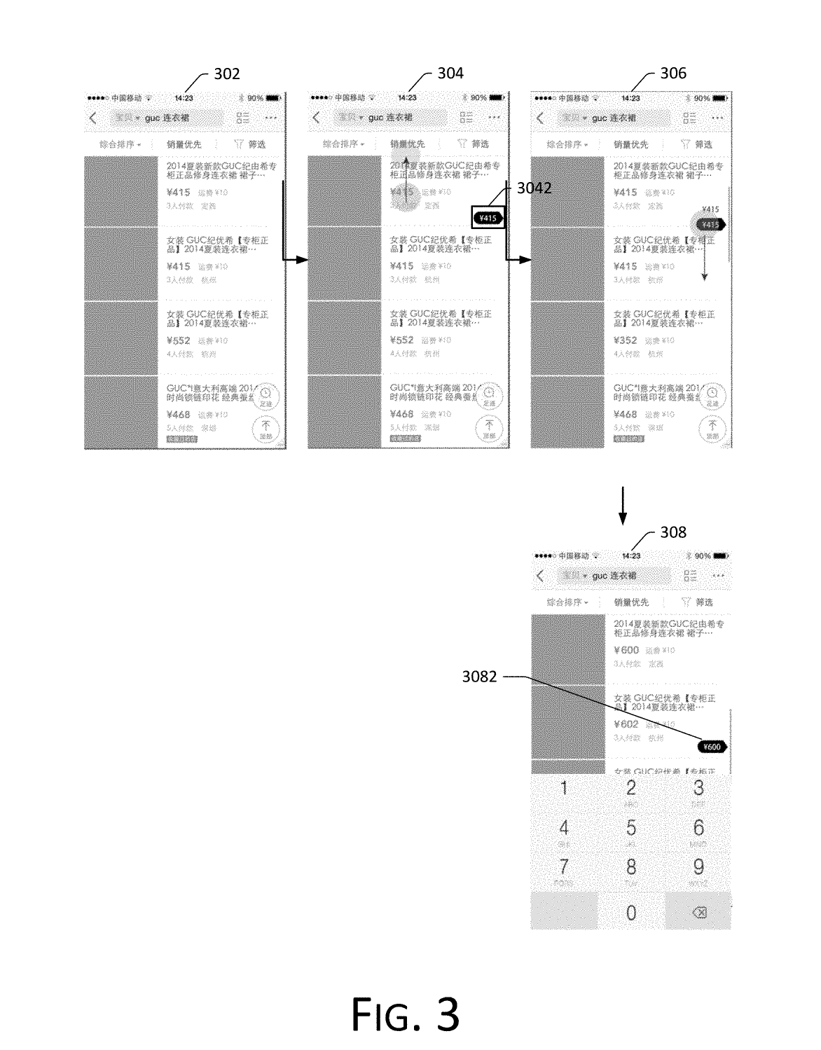

In order to enable the embodiments of the present disclosure to be comprehended more easily, an application scenario of price selection is used as an example hereinafter for describing a way of implementation in which the embodiments of the present disclosure are applied to a webpage browser, in conjunction with a page screenshot as shown in FIG. 3.

For example, when an initial state of a scrolling page is loaded in a webpage browser, as shown by a display window 302 of the webpage browser in FIG. 3, a control axis of an axis-shaped controller may be displayed only.

When a user begins to scroll the scrolling page, as shown by a display window 304 of the webpage browser in FIG. 3, a display label 3042 of the axis-shaped controller may be displayed. A product price “415” at the top of the display window 304 of the scrolling page may be displayed on the display label 3042.

During a process of moving the display label 3042 downwards by the user, a price displayed by the display label 3042 may change according to a product price of a content element at the top that is moved into the display window 304, and the user may quickly position a product at a target price according to the price displayed on the display label 3042. A label that displays the price is automatically displayed at a preset distance from the highest position of a focal point of moving (e.g., a finger-covered area in an implementation based on a touch screen). For example, a product at a price of 600 can be quickly positioned according to a displayed price label “600” as shown by a display window 306 of the webpage browser in FIG. 3.

After the user stops moving the display label for more than two seconds, the scrolling page is determined to be in a stationary state. The axis-shaped controller only displays the control axis, and the display label disappears, as shown by the display window 306 of the webpage browser in FIG. 3.

If the user clicks on the display label once again within two seconds, a label 3082 for displaying a price on the display label enters an edit state as shown in a display window 308 of the webpage browser in FIG. 3. The user may modify the price, and the user may click any position on the display window to confirm and acknowledge the modification after modifying the price. After the modification, the scrolling page automatically moves to cause products with the modified price to automatically move into the display window for display. Moreover, the display label and the color block on the control axis are also correspondingly moved to corresponding positions of the control axis to indicate a position of currently displayed content in the page.

As can be seen, a user can conveniently perform positioning from a product at one price to a product at another price by directly moving a display label, and can further preview product information while moving the display label to determine a price. If not satisfied with product(s) at that price, the user can move the display label once again, thus quickly previewing products at other prices. In addition, if products in the page are sorted according to prices, the user may further determine a price interval in which a currently displayed product is distributed according to a position of the display label on a control axis (an upper, middle or lower portion). As the user can conveniently find a product at a favorite price by operating the display label, interactions between the user and a terminal are reduced, thus saving the resources of the terminal.

Corresponding to the foregoing page information operating method, the embodiments of the present disclosure further provide a page information operating apparatus.

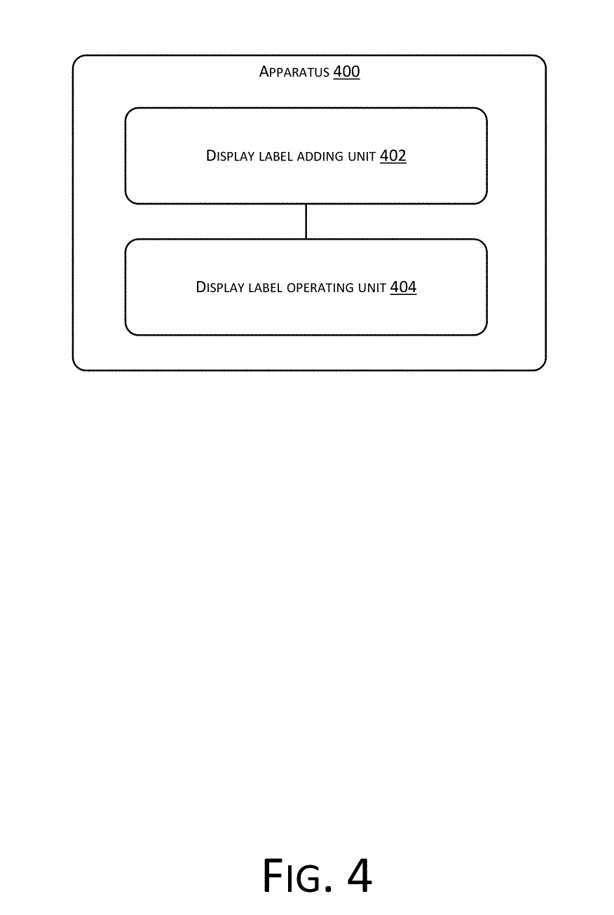

For example, FIG. 4 shows a structural diagram of a page information operating apparatus 400 according to an embodiment of the present disclosure. As shown in FIG. 4, the apparatus 400 may include a display label adding unit 402, which may be configured to add a display label to a display area of a scrolling page; and a display label operating unit 404, which may be configured to move the scrolling page correspondingly in as the display label is moved by a user, and display designated information that enters the display area of the scrolling page onto the display label.

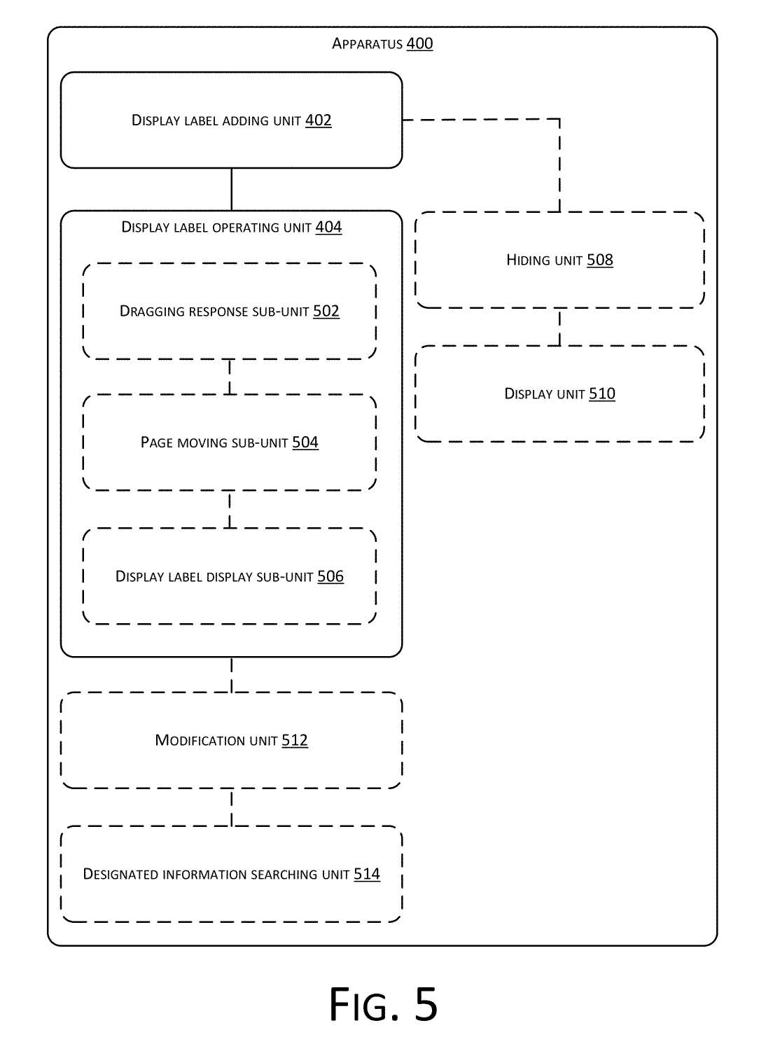

In implementations, the apparatus 400 may be configured in a webpage browser. As shown in FIG. 5, the display label adding unit 402 may be configured to add an axis-shaped controller having a display label in a display window of a webpage browser into which the scrolling page is loaded. The axis-shaped controller further includes a control axis, the control axis having a plurality of sections, with the plurality of sections individually corresponding to component ranges of respective sections of the total number of content elements in the scrolling page. The display label operating unit 404 may include a moving response sub-unit 502, which may be configured to determine a component range currently pointed by the display label based on a section on the control axis to which the display label is moved, in response to the display label being moved by the user; a page moving sub-unit 504, which may be configured to move a content element in the scrolling page that corresponds to the component range currently pointed by the display label into the display window for display by moving the scrolling page; and a display label display sub-unit 506, which may be configured to display designated information in the content element corresponding to the component range currently pointed onto the display label.

In order to prevent the content displayed on the display label from being covered by a focal point of moving and becoming not viewable due to the user's moving of the display label, the display label operating unit 404 may further be configured to display designated information displayed by the display label in a visible area that is not covered by the focal point of moving when the display label is moved by the user.

In order for the display label not to block the user from browsing page content, the apparatus 400 may further include a hiding unit 508, which may be configured to hide the display label when determining that the scrolling page is in a stationary state; and a display unit 510, which may be configured to display the display label when determining that the scrolling page is in a moving state.

In order to enable the user to quickly position target content of the scrolling page, the apparatus 400 may further include a modification unit 512, which may be configured to respond to modifies modification of the designated information displayed on the display label by the user, and obtain the modified designated information; and a designated information searching unit 514, which may be configured to search for a position of the modified designated information in the scrolling page, and move a found position into the display area for display by moving the scrolling page.

As can be seen, by setting up the apparatus 400, a display label adding unit 402 adds a display label to a display area of a scrolling page. As such, a user can move the display label in the display area, so that a display label operating unit 404 moves the scrolling page correspondingly as the display label is moved by the user, and displays designated information that enters the display area in the scrolling page onto the display label. The user may thus quickly find content that the user desires to view conveniently by directly moving the display label, and the user does not need to spend lots of time in frequently scrolling the scrolling page, thus avoiding a large number of interactions between the user and a terminal, and saving the resources of the terminal.

It should be noted that the moving response sub-unit 502, the page moving sub-unit 504, the display label display sub-unit 506, the hiding unit 508, the display unit 510, the modification unit 512, and the designated information searching unit 514 are drawn using dotted lines in FIG. 5, to indicate that these units are not essential units of the page information operating apparatus provided by the embodiments of the present disclosure.

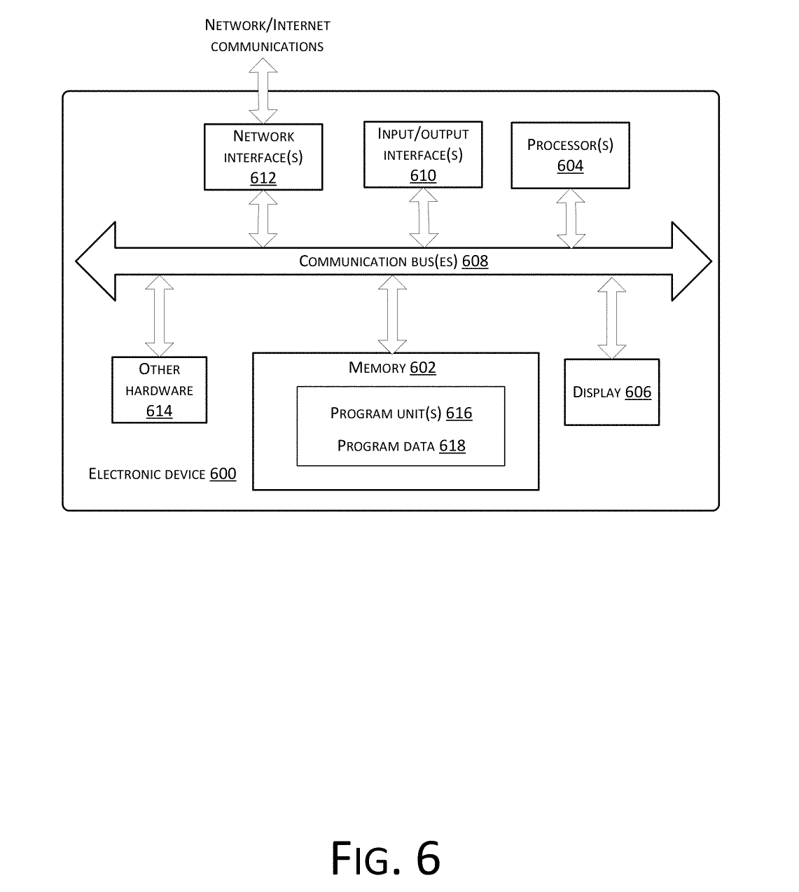

In implementations, an electronic device is further disclosed. For example, FIG. 6 shows a structural diagram of an electronic device 600 according to the present disclosure. As shown in FIG. 6, the electronic device 600 may include memory 602, one or more processors 604, a display 606 (such as a touch screen), and one or more communication buses 608. In some implementations, the electronic device 600 may further include an input/output (I/O) interface 610, a network interface 612, and other hardware 614.

The memory 602 may be configured to store program instructions. The program instructions are used for performing a method, which includes displaying a display label in a display area of a scrolling page that includes commodities and prices corresponding thereto; determining whether the display label is moved by a user based on touch position(s) detected by the touch screen; and if affirmative, moving the scrolling page correspondingly as the display label is moved by the user, and displaying a price of a commodity that enters a designated position in the display area of the scrolling page onto the display label.

The one or more processors 604 may be used for executing the program instructions stored in the memory 602.

The touch screen 606 may be used for displaying the display area of the scrolling page, and transmitting the detected touch position(s) when the touch screen 606 is touched by the user to the one or more processors 604.

The one or more communication buses 608 may be used for implementing connections and communications among the memory 602, the one or more processors 604, and the touch screen 606.

In implementations, the memory 602 may include program units 616 and program data 618. In implementations, the program units 616 may include one or more of the foregoing units/sub-units of the apparatus 400 as shown in FIGS. 4 and 5, for example.

In implementations, the memory 602 may include a form of computer-readable media, e.g., a non-permanent storage device, random-access memory (RAM) and/or a nonvolatile internal storage, such as read-only memory (ROM) or flash RAM. The memory 602 is an example of computer-readable media.

The computer-readable media may include a permanent or non-permanent type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer-readable media does not include transitory media, such as modulated data signals and carrier waves. For the ease of description, the system is divided into various types of units based on functions, and the units are described separately in the foregoing description. Apparently, the functions of various units may be implemented in one or more software and/or hardware components during an implementation of the present disclosure.

As can be seen, when a user browses commodities in certain websites using the electronic device disclosed in the embodiments of the present disclosure, the user may quickly find commodities at prices of interest by directly moving a display label, and does not need to spend a large amount of time in continuously scrolling the scrolling page, thus avoiding a great number of interactions between the user and a terminal, and saving resources of the terminal.

It may be understood that the program instructions described in the embodiments of the present disclosure, for example, may be a computer program. The method executed by the program instructions may include the method described in each embodiment herein and other implementations based on the methods according to the embodiments of the present disclosure, which are not repeatedly described herein.

For the sake of description, the above apparatus is divided into various units based on functionalities for individual descriptions. Apparently, when the present disclosure is implemented, the functions of the units may be implemented in one or more software components and/or hardware components.

Through the description of the foregoing implementations, one skilled in the art can clearly understand that the present disclosure may be implemented in software plus a necessary universal hardware platform. Based on such understanding, the essence of the technical solutions of the present disclosure or the parts that contribute to the existing technologies can be embodied in a form of a software product. The computer software product may be stored in a storage media such as a ROM/RAM, a magnetic disk, or an optical disk, etc., and contain instructions to instruct a computing device (which may be a personal computer, a server, a network device or the like) to perform the method as described in the embodiments or some parts of the embodiments of the present disclosure.

The embodiments in the specification are described in a progressive manner. Mutual reference can be made to the same or similar parts between the embodiments, and each embodiment focuses aspects different from other embodiments. Especially, for the system embodiments, the description is relatively simple due to their basic similarities to the method embodiments, and reference can be made to the description of related parts of the method embodiments.

The present disclosure is applicable to a large number of general or special computing system environments or configurations, for example, a personal computer, a sever computer, a handheld device or a portable device, a tablet device, a multi-processor system, a micro-processor based system, a set-top box, a programmable consumer electronic device, a network PC, a mini-computer, a mainframe computer, a distributed computing environment including any of the foregoing system or device, etc.

The present disclosure may be described in a general context of computer executable instructions executed by a computer, for example, program modules. Generally, the program modules include routines, programs, objects, components, data structures and other types of structures that execute designated tasks or implement particular abstract data types. The present disclosure may also be practiced in distributed computing environments. In these distributed computing environments, tasks are executed by remote processing devices connected via a communication network. In a distributed computing environment, program modules may be located in both local and remote memory storage media including a storage device.

It should be noted that relational terms such as first and second in the text are merely used to distinguish one entity or operation from another entity or operation, but may not necessarily require or imply that these entities or operations have any of such type of actual relationship or order therebetween. Moreover, terms “include” and “comprise” or any other variations intend to cover non-exclusive inclusion, so that processes, methods, articles or devices including a series of elements not only include the elements, but also include other elements not explicitly listed, or also include inherent elements of the processes, methods, articles or devices. Without any more limitations, elements defined by an expression “including . . . ,” do not exclude the processes, methods, articles or devices that include the elements from having other additional identical elements.

The above descriptions are merely preferred embodiments of the present disclosure, but are not intended to limit the scope of protection of the present disclosure. Any modifications, equivalent replacements, improvements, etc., that are made without departing from the spirit and principle of the present disclosure shall all fall within the scope of protection of the present disclosure.

1. A method comprising:
displaying a display label in a display area of a page, the display label having first designated information at a first position, the first designated information associated with first content displayed in the display area; and
changing a display of the page as the display label is moved by a user from the first position to a second position, the display label having second designated information at the second position, and the second designated information associated with second content displayed in the display area.

2. The method of claim 1, wherein displaying the display label in the display area of the page comprises adding an axis-shaped controller having the display label in a display window of a webpage browser into which the page is loaded, wherein the axis-shaped controller further comprises a control axis, the control axis has a plurality of sections, and the plurality of sections individually correspond to component ranges of respective sections of a total number of content elements in the page.

3. The method of claim 2, wherein changing the display of the page as the display label is moved by the user from the first position to the second position comprises:
in response to the display label being moved by the user, determining a component range currently pointed by the display label based on a section of the control axis to which the display label is moved; and
moving a content element in the page which corresponds to the component range currently pointed by the display label into the display window for display by moving the page.

4. The method of claim 3, wherein changing the display of the page comprises displaying a corresponding piece of designated information in the content element corresponding to the component range currently pointed onto the display label.

5. The method of claim 1, wherein changing the display of the page comprises displaying the second designated information displayed by the display label in a visible area not covered by a focal point of moving as the display label is moved by the user.

6. The method of claim 1, further comprising hiding the display label after determining that the page changes from a moving state into a stationary state.

7. The method of claim 1, further comprising:
in response to the first designated information displayed on the display label being modified by the user, obtaining the modified designated information;
searching for a position of the modified designated information in the page; and
moving a found position into the display area for display by moving the page.

8. The method of claim 1, wherein the page comprises a page including commodity information and corresponding prices, and the second designated information comprises a price corresponding to a commodity entering a designated position of the display area of the page.

9. The method of claim 6, further comprising reordering the commodity information in the page according to the corresponding prices in response to receiving an ordering event triggered by performing a designated operation on the display label by the user.

10. An apparatus implemented by a computing device, the apparatus comprising:
a display label adding unit to add a display label into a display area of a page, the display label having first designated information at a first position, the first designated information associated with first content displayed in the display area; and
a display label operating unit to change a display of the page as the display label is moved by a user from the first position to a second position, the display label having second designated information at the second position, and the second designated information associated with second content displayed in the display area.

11. The apparatus of claim 10, wherein:
the display label adding unit is further configured to add an axis-shaped controller having the display label in a display window of a webpage browser into which the page is loaded, wherein the axis-shaped controller further comprises a control axis, the control axis has a plurality of sections, and the plurality of sections individually correspond to component ranges of respective sections of a total number of content elements in the page, and
the display label operating unit is further configured to:
determine a component range currently pointed by the display label based on a section of the control axis to which the display label is moved in response to the display label being moved by the user,
move a content element of the page which corresponds to the component range currently pointed by the display label into the display window for display by moving the page, and
display a corresponding piece of designated information in the content element corresponding to the component range currently pointed onto the display label.

12. The apparatus of claim 10, wherein the display label operating unit is further configured to display the second designated information displayed by the display label in a visible area not covered by a focal point of moving as the display label is moved by the user.

13. The apparatus of claim 10, further comprising:
a hiding unit configured to hide the display label in response to determining that the page is in a stationary state; and
a display unit configured to display the display label in response to determining that the page is in a moving state.

14. The apparatus of claim 10, further comprising:
a modification unit configured to obtain modified designated information in response to the second designated information displayed on the display label being modified by the user; and
a designated information searching unit configured to search for a position of the modified designated information in the page, and move a found position into the display area for display by moving the page.

15. One or more computer-readable media storing executable instructions that, when executed by one or more processors, cause the one or more processors to perform operations comprising:
displaying a display label in a display area of a page, the display label having first designated information at a first position, the first designated information associated with first content displayed in the display area; and
changing a display of the page as the display label is moved by a user from the first position to a second position, the display label having second designated information at the second position, and the second designated information associated with second content displayed in the display area.

16. The one or more computer-readable media of claim 15, wherein displaying the display label in the display area of the page comprises adding an axis-shaped controller having the display label in a display window of a webpage browser into which the page is loaded, wherein the axis-shaped controller further comprises a control axis, the control axis has a plurality of sections, and the plurality of sections individually correspond to component ranges of respective sections of a total number of content elements in the page.

17. The one or more computer-readable media of claim 16, wherein changing the display of the page correspondingly as the display label is moved by the user from the first position to the second position comprises:
in response to the display label being moved by the user, determining a component range currently pointed by the display label based on a section of the control axis to which the display label is moved; and
moving a content element in the page which corresponds to the component range currently pointed by the display label into the display window for display by moving the page.

18. The one or more computer-readable media of claim 17, wherein changing the display of the page comprises displaying a corresponding piece of designated information in the content element corresponding to the component range currently pointed onto the display label.

19. The one or more computer-readable media of claim 15, wherein changing the display of the page comprises displaying the second designated information displayed by the display label in a visible area not covered by a focal point of moving as the display label is moved by the user.

20. The one or more computer-readable media of claim 15, the operations further comprising hiding the display label after determining that the page changes from a moving state into a stationary state.
